(19) United States
(12) Patent Application Publication
(10) Pub. No.: US 2014/0358605 A1
(43) Pub. Date: Dec. 4, 2014

(54) METHODS AND SYSTEMS FOR CROWDSOURCING A TASK

(71) Applicant: XEROX CORPORATION, Norwalk, CT (US)

(72) Inventors: Chithralekha Balamurugan, Pondicherry (IN); Sujit Gujar, Bangalore (IN); Shourya Roy, Bangalore (IN)

(21) Appl. No.: 13/909,181

(22) Filed: Jun. 4, 2013

(51) Int. Cl. G06Q 10/06

(52) U.S. Cl. CPC G06Q 10/06311
USPC 705/7.13

(57) ABSTRACT

The disclosed embodiments illustrate methods and systems for crowdsourcing a task. The method comprises presenting the task to one or more crowdworkers based on their reputation scores and a redundancy degree associated with the task. The task comprises one or more sub-tasks. A plurality of responses to the task are received from the one or more crowdworkers. Each response further comprises one or more sub-responses each of which in turn corresponds to a response for a sub-task of the one or more sub-tasks. A first set of sub-tasks is identified from the one or more sub-tasks based on a first set of similar sub-responses received for the first set of sub-tasks from the plurality of responses. A first set of crowdworkers from the one or more crowdworkers who provided the first set of similar sub-responses for the first set of sub-tasks are remunerated.

### TECHNICAL FIELD

The presently disclosed embodiments are related, in general, to crowdsourcing. More particularly, the presently disclosed embodiments are related to systems and methods for managing a crowdsourced task.

### BACKGROUND

Various organizations and individuals may crowdsource tasks to one or more crowdworkers through a crowdsourcing platform. Some organizations maintain an application server that registers the tasks for crowdsourcing purposes. The crowdsourcing platform may assign the tasks to a group of crowdworkers. Further, the crowdsourcing platform server receives one or more responses for the tasks from the crowdworkers. The application server at the organization may employ one or more correctness resolution techniques to validate responses for the tasks, received from the group of crowdworkers through the crowdsourcing platform. One example of such correctness resolution technique is a consensus-based validation. In the consensus-based validation, the application server determines a task as complete if all the received responses are similar to one another. Payment for the task may then be disbursed to all those crowdworkers who submitted such similar responses.

The task may be re-assigned to another group of crowdworkers if the number of similar responses received for the task is less than a predetermined threshold. In certain scenarios, the number of similar responses provided by latter group of crowdworkers may be more than the predetermined threshold. However, one or more crowdworkers from the former group of crowdworkers may have already provided the same responses. The crowdworkers from the latter group may be remunerated while the one or more crowdworkers from the former group may be denied payment, although similar responses are provided by both categories of crowdworkers. This leads to a reduction in crowdworkers' loyalty and increases the time required to complete the task. The task throughput reduces as the task may be re-assigned repeatedly. Thus, there exists a need for improvement in crowdsourcing of tasks to improve crowdworkers' loyalty and task throughput.

### SUMMARY

According to embodiments illustrated herein there is provided a method for crowdsourcing of a task. The method includes presenting the task to one or more crowdworkers based on a reputation score associated with each of the one or more crowdworkers and a degree of redundancy associated with the task. The task comprises one or more sub-tasks. A plurality of responses for the task is received from the one or more crowdworkers. Each response from the plurality of responses comprises one or more sub-responses, and each of the one or more sub-responses corresponds to a response for a sub-task of the one or more sub-tasks. Thereafter, a first set of sub-tasks from the one or more sub-tasks is identified based on a first set of similar sub-responses received for the first set of sub-tasks from the plurality of responses and a first predetermined number. Then, a first set of crowdworkers, who have provided the first set of similar sub-responses for the first set of sub-tasks, from the one or more crowdworkers are remunerated. The method is performed by a processor on a computing device.

According to embodiments illustrated herein there is provided a crowdsourcing management system for managing crowdsourcing of a task. The crowdsourcing management system includes a processor and a memory. The memory includes a task manager, a communication manager, a redundancy handler and a remuneration manager. The task manager is configured to present the task to one or more crowdworkers based on a reputation score associated with each of the one or more crowdworkers and a degree of redundancy associated with the task. The task comprises one or more sub-tasks. The communication manager is configured to receive a plurality of responses for the task from the one or more crowdworkers. Each response from the plurality of responses comprises one or more sub-responses, and each of the one or more sub-responses corresponds to a response for a sub-task of the one or more sub-tasks. The redundancy handler is configured to identify a first set of sub-tasks from the one or more sub-tasks based on a first set of similar sub-responses received for the first set of sub-tasks from the plurality of responses and a first predetermined number. The remuneration manager is configured to remunerate a first set of crowdworkers from the one or more crowdworkers. The first set of crowdworkers corresponds to the crowdworkers who have provided the first set of similar sub-responses for the first set of sub-tasks.

According to embodiments illustrated herein there is provided a computer program product for use with a computing device. The computer program product includes a non-transitory computer-readable medium having a computer readable program code embodied therein for crowdsourcing of a task. The computer readable program code is executable by a processor in the computing device for presenting the task to one or more crowdworkers based on a reputation score associated with each of the one or more crowdworkers and a degree of redundancy associated with the task. The task comprises one or more sub-tasks. A plurality of responses for the task is received from the one or more crowdworkers. Each response from the plurality of responses comprises one or more sub-responses, and each of the one or more sub-responses corresponds to a response for a sub-task of the one or more sub-tasks. Thereafter, a first set of sub-tasks from the one or more sub-tasks is identified based on a first set of similar sub-responses received for the first set of sub-tasks from the plurality of responses and a first predetermined number. Then, a first set of crowdworkers, who have provided the first set of similar sub-responses for the first set of sub-tasks, from the one or more crowdworkers are remunerated.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram of a system environment in which various embodiment can be implemented;

FIG. 2 is a block diagram illustrating a system for crowdsourcing a task, in accordance with at least one embodiment; and

FIG. 3 is a flowchart illustrating a method for crowdsourcing a task, in accordance with at least one embodiment;

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “task” refers to a piece of work, an activity, an action, a job, an instruction, or an assignment to be performed. Tasks may necessitate the involvement of one or more workers. Examples of tasks include, but are not limited to, digitization of a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk and Crowd Flower.

A “crowdsourcing platform” refers to a business application, wherein a broad, loosely defined external group of people, communities, or organizations provides solutions as outputs for any specific business processes received by the application as input. In an embodiment, the business application may be hosted online on a web portal (e.g., the crowdsourcing platform servers). Various examples of the crowdsourcing platforms include, but are not limited to, Amazon Mechanical Turk or Crowd Flower.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker” “crowdsourced workforce”, and “crowd” may be interchangeably used.

A “reputation score” refers to a measure of performance reputation of a crowdworker.

A “redundancy degree” refers to a maximum number of crowdworkers who are presented with a task.

An “agreement degree” refers to a minimum number of similar responses required for task acceptance. For example, if the agreement degree of a task is three, at least three similar responses to the task from three crowdworkers are required for accepting the task as complete.

A “re-assignment degree” refers to a maximum number of times a task may be re-assigned to crowdworkers. For example, if the agreement degree of the task is five and the re-assignment degree of the task is three and if two similar responses are received for the task, the task is re-assigned to crowdworkers until five similar responses are received or until the task has been re-assigned three times which ever is earlier.

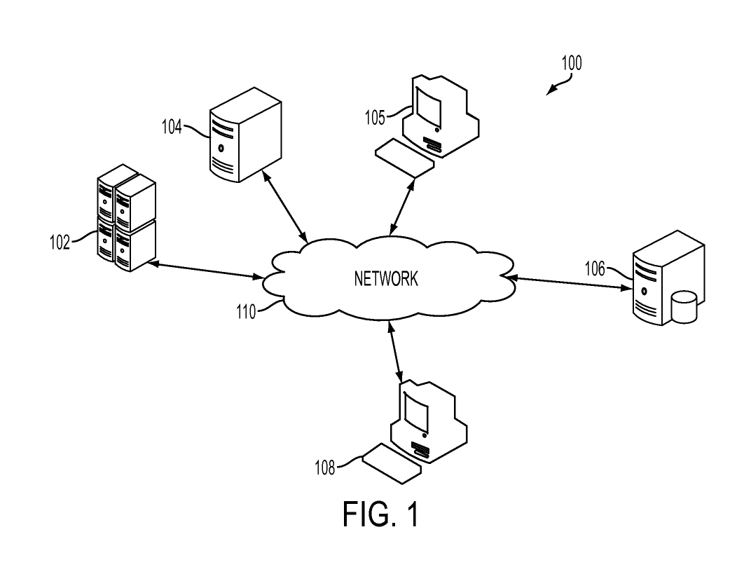

FIG. 1 is a block diagram of a system environment 100 in which various embodiments can be implemented. The system environment 100 includes a crowdsourcing platform server 102, an application server 104, a requestor computing device 105, a database server 106, a crowdworker computing device 108, and a network 110.

The crowdsourcing platform server 102 is configured to host one or more crowdsourcing platforms. One or more crowdworkers are registered with the one or more crowdsourcing platforms. Further, the crowdsourcing platform offers one or more tasks to the one or more crowdworkers. In an embodiment, the crowdsourcing platform presents a user interface to the one or more crowdworkers through a web-based interface or a client application. The one or more crowdworkers may access the one or more tasks through the web-based interface or the client application. Further, the one or more crowdworkers may submit a response to the crowdsourcing platform through the user interface. In an embodiment, the crowdsourcing platform server 102 may be realized through an application server such as, but not limited to, Java application server, .NET framework, and Base4 application server.

The application server 104 is configured to generate the one or more tasks for completion through crowdsourcing. In an embodiment, each task comprises one or more sub-tasks. The application server 104 uploads the one or more tasks and one or more characteristics associated with the one or more tasks on the crowdsourcing platform. In an embodiment, the crowdsourcing platform distributes the one or more tasks to the one or more crowdworkers. In an embodiment, task distribution may be based on a reputation score associated with each of the one or more crowdworkers. Further, the task distribution may also be based on the one or more characteristics of the one or more tasks. Some examples of the application server 104 may include, but not limited to, Java application server, .NET framework, and Base4 application server.

A person having ordinary skills in the art would understand that the scope of the disclosure is not limited to illustrating the application server 104 as a separate entity. In an embodiment, the functionality of the application server 104 may be implementable on/integrated with the crowdsourcing platform server 102.

The requestor computing device 105 is a computing device used by a requestor. The requestor sends the one or more task requests to the application server 104 from the requestor computing device 105. In an embodiment, the application server 104 then generates the one or more tasks for crowdsourcing based on the one or more task requests. Examples of the requestor computing device 105 include, but are not limited to, a personal computer, a laptop, a personal digital assistant (PDA), a mobile device, a tablet, or any other computing device known in the art.

A person having ordinary skills in the art would understand that the scope of the disclosure is not limited to illustrating the application server 104 and the requestor computing device 105 as separate entities. In an embodiment, the functionality of the application server 104 may be implementable (as a software application) on the requestor computing device 105.

The database server 106 stores information associated with the one or more crowdworkers. Further, the database server 106 stores information associated with the one or more uploaded tasks. In an embodiment, the database server 106 may receive a query from at least one of the crowdsourcing platform server 102 or the application server 104 to extract information associated with the one or more crowdworkers, or the one or more uploaded tasks. The database server 106 may be realized through various technologies, such as, but not limited to, Microsoft® SQL server, Oracle, and My SQL. In an embodiment, the crowdsourcing platform server 102 and/or the application server 104 may connect to the database server 106 using one or more protocols such as, but not limited to, ODBC protocol and JDBC protocol.

A person having ordinary skills in the art would understand that the scope of the disclosure is not limited to the database server 106 as a separate entity. In an embodiment, the functionalities of the database server 106 can be integrated into the crowdsourcing platform server 102 and/or the application server 104.

The crowdworker computing device 108 is a computing device used by a crowdworker. The crowdworker computing device 108 is configured to present the user interface (received from the crowdsourcing platform) to a crowdworker. The crowdworker receives the one or more tasks from the crowdsourcing platform through the user interface. Further, the crowdworker submits the response through the user interface to the crowdsourcing platform. Some examples of the crowdworker computing device 108 include a personal computer, a laptop, a PDA, a mobile device, a tablet, or any device that has the capability to display the user interface.

The network 110 corresponds to a medium through which content and messages flow between various devices of the system environment 100 (e.g., the crowdsourcing platform server 102, the application server 104, the requestor computing device 105, the database server 106, and the crowdworker computing device 108). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as Transmission Control Protocol and Internet Protocol (TCP/IP), User Datagram Protocol (UDP), and 2G, 3G, or 4G communication protocols.

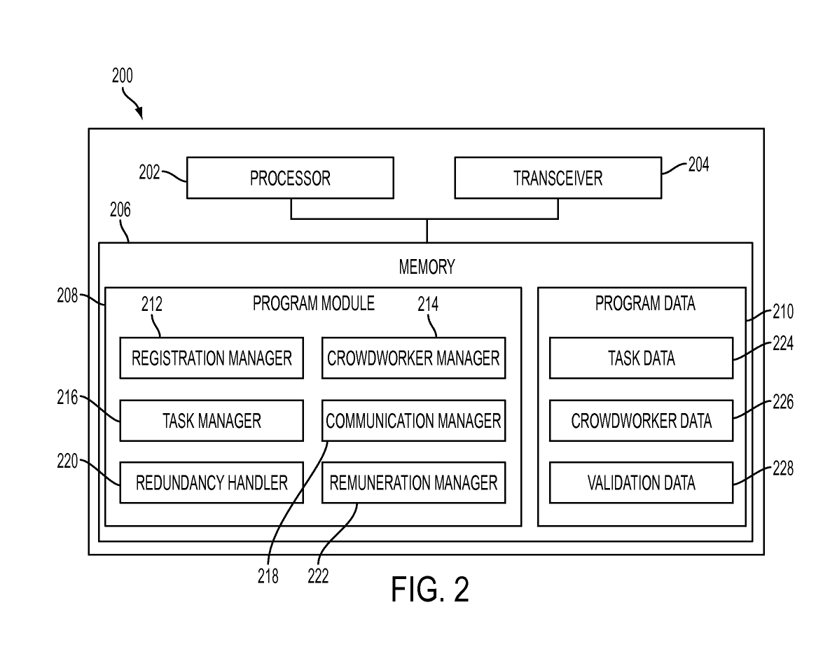

FIG. 2 is a block diagram illustrating a system 200 for crowdsourcing a task, in accordance with at least one embodiment. The system 200 includes a processor 202, a transceiver 204, and a memory 206. In an embodiment, the system 200 may correspond to the crowdsourcing platform server 102 or the application server 104. For the purpose of ongoing description, the system 200 is considered as the application server 104. However, the scope of the disclosure should not be limited to the system 200 as the application server 104. The system 200 can also be realized as the crowdsourcing platform server 102.

The processor 202 is coupled to the transceiver 204 and the memory 206. The processor 202 executes a set of instructions (as various program instruction modules) stored in the memory 206 to perform a predetermined operation on the system 200. The processor 202 can be realized through a number of processor technologies known in the art. Examples of the processor 202 may include, but are not limited to, X86 processor, RISC processor, ASIC processor, CISC processor, ARM processor, or any other processor.

The transceiver 204 transmits and receives messages and data to/from various devices of the system environment 100 (e.g., the crowdsourcing platform server 102, the requestor computing device 105, the database server 106, and the crowdworker computing device 108). Examples of the transceiver 204 may include, but are not limited to, an antenna, an Ethernet port, a USB port or any other port that can be configured to receive and transmit data. The transceiver 204 transmits and receives data/messages in accordance with various communication protocols, such as, TCP/IP, UDP, and 2G, 3G, or 4G communication protocols.

The memory 206 stores a set of instructions and data. Some of the commonly known memory implementations include, but are not limited to, a random access memory (RAM), a read only memory (ROM), a hard disk drive (HDD), and a secure digital (SD) card. Further, the memory 206 includes a program module 208 and a program data 210.

The program module 208 includes a set of instructions that is executable by the processor 202 to perform specific operations on the system 200. The program module 208 includes various program instructions modules such as a registration manager 212, a crowdworker manager 214, a task manager 216, a communication manager 218, a redundancy handler 220, and a remuneration manager 222.

The program data 210 includes a task data 224, a crowdworker data 226, and a validation data 228.

The registration manager 212 receives the one or more task requests from the requestor (through the requestor computing device 105). The registration manager 212 may also receive the one or more characteristics associated with each task request. The one or more characteristics includes, but are not limited to, a redundancy degree, an agreement degree, a re-assignment degree, a reputation score threshold, a remuneration amount value, and a completion date. In an embodiment, the registration manager 212 generates the one or more tasks based on the one or more received task requests and the one or more characteristics. Thereafter, the registration manager 212 stores the one or more generated tasks and the one or more characteristics associated with each generated task to the task data 224. In an embodiment, each generated task comprises the one or more sub-tasks.

For the sake of brevity, rest of the disclosure is described with respect to a single task. However, those skilled in the art would appreciate that the disclosure may be implemented with respect to more than one task in a similar manner.

The crowdworker manager 214 maintains profiles of the one or more crowdworkers associated with the crowdsourcing platform. In an embodiment, the profile may include information such as, but not limited to, a user name, a password, contact details, qualification information, work experience information, skill set information, and a reputation score. In an embodiment, the crowdworker manager 214 maintains the profiles as the crowdworker data 226. In an embodiment, during creation of the profile of a new crowdworker, the crowdworker manager 214 calculates the reputation score of the new crowdworker based on the qualification information, the work experience information, and the skill set information of the crowdworker. Additionally, the crowdworker manager 214 updates the reputation score of each crowdworker based on his/her performance on the one or more tasks.

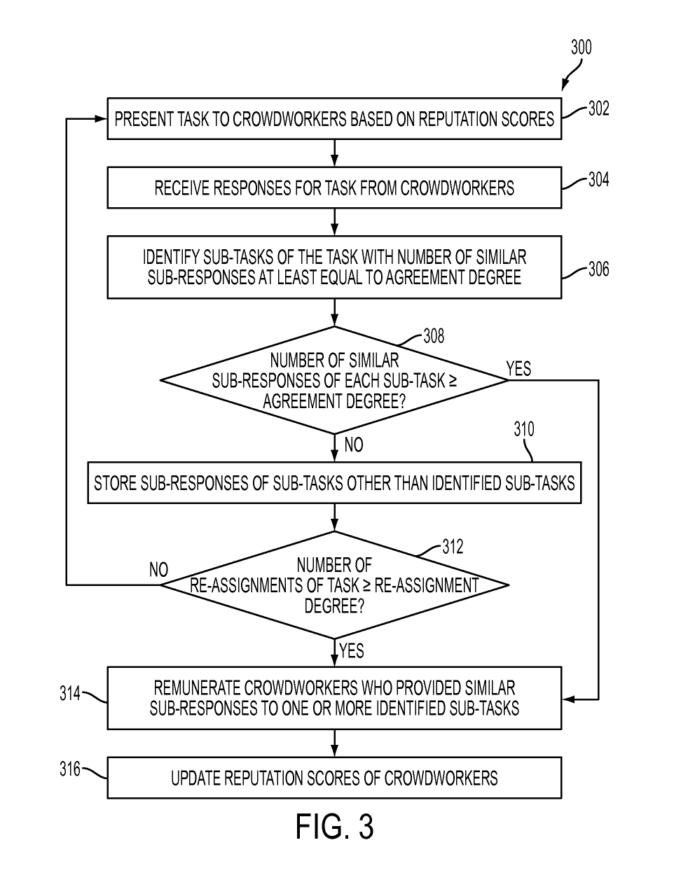

The task manager 216 retrieves a task and the one or more characteristics associated with the retrieved task from the task data 224. Additionally, the task manager 216 determines the reputation scores associated with the one or more crowdworkers from the crowdworker data 226. The task manager 216 assigns the task to the one or more crowdworkers through the crowdsourcing platform based on the one or more characteristics and the reputation scores. The assignment of the task is described later in conjunction with FIG. 3.

The communication manager 218 uploads the task to the crowdsourcing platform through the transceiver 204. Additionally, the communication manager 218 receives one or more user responses for the task from the one or more crowdworkers through the crowdsourcing platform. Each received response comprises one or more sub-responses each of which corresponds to a response for a sub-task of the one or more sub-tasks within the task. In a scenario where the system 200 is implemented as the crowdsourcing platform server 102, the communication manager 218 transmits the user interface corresponding to the task to the crowdworker computing device 108 of each of the one or more crowdworkers through the transceiver 204. Further, the communication manager 218 receives the one or more responses from the crowdworker computing device 108 through the user interface. The communication manager 218 includes various protocol stacks such as, but not limited to, TCP/IP, UDP, and 2G, 3G, or 4G communication protocols. The communication manager 218 transmits and receives the messages/data (e.g., images) through the transceiver 204 in accordance with such protocol stacks.

The redundancy handler 220 analyzes the one or more responses received by the communication manager 218 for the task from the one or more crowdworkers. The redundancy handler 220 compares the sub-responses received for the sub-task to determine similar sub-responses for each sub-task. The redundancy handler 220 identifies at least one sub-task from the one or more sub-tasks based on a count of similar sub-responses and the agreement degree associated with the task. In an embodiment, the redundancy handler 220 stores the received sub-responses in the validation data 228 for future comparisons. Additionally, the redundancy handler 220 instructs the crowdworker manager 214 to update the reputation score of the one or more crowdworkers based on the identified at least one sub-task. The identification of the at least one sub-task is described later in conjunction with FIG. 3.

The remuneration manager 222 remunerates a first set of crowdworkers from the one or more crowdworkers who provided the similar sub-responses for the identified at least one sub-task.

FIG. 3 is a flowchart 300 illustrating a method for crowdsourcing a task, in accordance with at least one embodiment. The flowchart 300 is described in conjunction with FIG. 1 and FIG. 2.

At step 302, the task is presented to the one or more crowdworkers through the crowdsourcing platform based on the reputation score of each crowdworker. In an embodiment, the task manager 216 presents the task to the one or more crowdworkers. Prior to presenting the task, the task manager 216 retrieves the task and the one or more characteristics associated with the task from the task data 224. In an embodiment, the task includes the one or more sub-tasks. Further, the task manager 216 retrieves the reputation scores of the one or more crowdworkers from the crowdworker data 226. Thereafter, the task manager 216 compares the reputation scores of the one or more crowdworkers with the reputation score threshold of the task and presents the task to the one or more crowdworkers accordingly. In an embodiment, each of the one or more crowdworkers presented with the task have reputation scores greater than or equal to the reputation score threshold of the task. For example, if the reputation score threshold of the task is 6, the crowdworkers with reputation scores greater than or equal to 6 are presented with the task. In an embodiment, a count of the one or more crowdworkers who are presented the task is less than or equal to the redundancy degree of the task. As the task is presented to those crowdworkers who have reputation scores at least equal to the reputation score threshold of the task, there is a high probability of receiving correct responses.

At step 304, the one or more responses are received for the task from the one or more crowdworkers. The communication manager 218 receives these one or more responses for the task. In an embodiment, each of the one or more responses includes one or more sub-responses for each of the one or more sub-tasks in the task.

At step 306, a first set of sub-tasks is identified from the one or more sub-tasks of the task based on the count of similar sub-responses received for the first set of sub-tasks and the agreement degree associated with the task. In an embodiment, the count of similar sub-responses received for each sub-task in the first set of sub-tasks is greater than or equal to the agreement degree of the task. For example, the task includes 10 sub-tasks. If the agreement degree of the task is 4, for each of the 10 sub-tasks, 4 or more similar sub-responses are required to mark a sub-task as complete. The redundancy handler 220 also identifies a first set of crowdworkers from the one or more crowdworkers who provided the similar sub-responses for the at least one sub-task in the first set of sub-tasks.

In an embodiment, the one or more sub-tasks include a test sub-task that has a pre-determined value corresponding to an acceptable sub-response. In an embodiment, the pre-determined value of the test sub-task is pre-stored in the validation data 228. In addition, one or more sub-responses to the test sub-task are compared to the predetermined value to validate the one or more crowdworkers as genuine non-spamming crowdworkers.

The redundancy handler 220 retrieves the pre-determined value corresponding to the acceptable sub-response of the test sub-task from the validation data 228. The redundancy handler 220 then compares the sub-responses received for the test sub-task from the one or more crowdworkers with the predetermined value. If a sub-response for the test sub-task from a crowdworker is similar to the predetermined value, the redundancy handler 220 validates the crowdworker as the genuine non-spamming crowdworker.

In an alternate embodiment, the redundancy handler 220 compares the one or more sub-responses of the test sub-task with one another to determine similar sub-responses for the test sub-task. In this scenario, if the number of similar sub-responses to the test sub-task is greater than or equal to the agreement degree of the task, the crowdworkers who provided these similar sub-responses are validated as the genuine non-spamming crowdworkers.

In an embodiment, the redundancy handler 220 requests the crowdworker manager 214 to modify the reputation scores of crowdworkers who provided sub-responses for the test sub-task that are not similar to the predetermined value associated with the test sub-task. The crowdworker manager 214 stores the updated reputation scores to the crowdworker data 226. In another embodiment, the redundancy handler 220 requests the crowdworker manager 214 to blacklist crowdworkers whose sub-responses to the test sub-task is not same as the predetermined value. The blacklisted crowdworkers are not presented with a task again. This leads to a reduction in the number of spamming incidents.

A person skilled in the art would understand that the scope of the disclosure is not limited to validating the crowdworker by presenting the test sub-task. In an embodiment, the crowdworker may be validated using one or more known techniques such as, but not limited to, CAPTCHA and reCAPTCHA, or any suitable validation techniques.

At step 308, a check is performed to determine whether the similar sub-response count of each sub-task of the task is greater than or equal to the agreement degree of the task. In an embodiment, the redundancy handler 220 performs the check. If it is determined that the similar sub-response count of each sub-task in the task is greater than or equal to the agreement degree, step 314 is performed. If it is determined that the similar sub-response count of each sub-task is less than the agreement degree, step 310 is performed. Consider the example scenario discussed in step 306 where the agreement degree of the task was 4. If 4 or more similar sub-responses are received for 7 sub-tasks out of the total 10 sub-tasks, step 310 is performed. Step 314 is performed when 4 or more similar sub-responses are received for all the 10 sub-tasks of the task.

At step 310, the sub-responses for all sub-tasks other than the identified first set of sub-tasks are stored. Hereinafter, the sub-tasks other than the identified first set of sub-tasks are referred as a second set of sub-tasks. In an embodiment, the redundancy handler 220 stores the sub-responses for the second set of sub-tasks as the validation data 228. Considering the example discussed in step 308, the redundancy handler 220 stores the received sub-responses for the 3 sub-tasks that have less than 4 similar sub-responses.

At step 312, a check is performed to determine whether the number of re-assignments of the task is greater than or equal to the re-assignment degree of the task. In an embodiment, the redundancy handler 220 performs this check. If it is determined that the number of re-assignments of the task is greater than or equal to the re-assignment degree, step 314 is performed. If it is determined that the number of re-assignments of the task is less than the re-assignment degree, step 302 is performed leading to the task re-assignment.

In a scenario where the task is re-assigned, steps 302 onwards are performed again. The task manager 216 presents the task to a second set of crowdworkers from the one or more crowdworkers based on their reputation scores as explained in step 302. The communication manager 214 receives a second set of responses from the second set of crowdworkers for the task as explained in step 304. The redundancy handler 220 retrieves the stored sub-responses (stored at step 310) for the second set of sub-tasks (for which the similar sub-response count was less than the agreement degree) from the validation data 228. The second set of responses comprises a second set of sub-responses for the second set of sub-tasks. The redundancy handler 220 compares the stored sub-responses and the second set of sub-responses for the second set of sub-tasks to determine similar sub-responses for the second set of sub-tasks. Thereafter, the redundancy handler 220 identifies a third set of sub-tasks from the second set of sub-tasks such that the similar sub-response count of each sub-task in the third set of sub-tasks are greater than or equal to the agreement degree of the task as explained in step 306. In an embodiment, the similar sub-response count is determined as the sum of similar sub-responses for the third set of sub-tasks in the second set of received sub-responses and the similar stored sub-responses.

For example, if A, B and C are the three sub-tasks with less than 4 similar sub-responses (i.e., agreement degree). For instance, 3, 2, and 2 similar sub-responses are received and subsequently stored for the respective sub-tasks A, B, and C. The redundancy handler 220 compares the second set of received sub-responses with stored sub-responses corresponding to the three sub-tasks. If 2, 3, and 1 similar sub-responses are received in the second set of received sub-responses for the three sub-tasks, sub-tasks A and B (with 5=3+2 similar sub-responses each) are deemed complete, whereas sub-task C (with 3=2+1 similar sub-responses) is still incomplete.

The redundancy handler 220 also identifies a third set of crowdworkers from the one or more crowdworkers who provided the similar sub-responses to at least one sub-task in the third set of sub-tasks. The third set of crowdworkers includes crowdworkers whose sub-responses to the second set of sub-tasks were stored at step 310 and correspond to the similar sub-responses for the third set of sub-tasks. In addition, the third set of crowdworkers further includes one or more crowdworkers from the second set of crowdworkers who provided the similar sub-responses. The task is re-assigned until either the similar sub-response count of each sub-task is greater than or equal to the agreement degree of the task or the number of re-assignments of the task is greater than the re-assignment degree of the task.

At step 314, crowdworkers who have provided the similar sub-responses for one or more sub-tasks with the similar sub-response count greater than or equal to the agreement degree of the task are remunerated. In an embodiment, the remuneration manager 222 remunerates the first and the third set of crowdworkers.

A crowdworker is remunerated if sub-responses provided by the crowdworker correspond to the similar sub-responses for the one or more sub-tasks with similar sub-response count greater than or equal to the agreement degree of the task. However, if the sub-responses provided by the crowdworker do not correspond to the similar sub-responses, the crowdworker sub-responses are stored for future comparisons. Thereafter, when the task is re-assigned, one or more of these crowdworker sub-responses may correspond to the similar sub-responses based on the second set of received sub-responses. Thus, the crowdworker sub-responses are not out-rightly rejected if they do not contribute to the immediate completion of the one or more sub-tasks. The crowdworker sub-responses are stored for future comparisons thereby re-using them in ascertaining completion of the one or more sub-tasks. This reduces the time taken to complete the entire task and improves the task throughput rate. The crowdworkers are genuinely remunerated and hence the crowdworker loyalty improves.

At step 316, the reputation score associated with each crowdworker is updated. In an embodiment, the crowdworker manager 214 updates the reputation scores of the each crowdworker based on his/her sub-responses to the different sub-tasks within the task. In an embodiment, the crowdworker manager 214 assigns an initial value of 1 to the reputation score. Thereafter, in an embodiment, the crowdworker manager 214 uses the following equation to determine the reputation score:

$$W ( t ) = \frac{k + K}{t + K}$$

where,

W: Reputation score associated with each crowdworker;

K: Number of correctly attempted tasks by the crowdworker before the current set of the one or more tasks;

t: Total number of tasks attempted by the crowdworker from the current set of the one or more uploaded tasks; and

k: Number of correctly attempted tasks by the crowdworker from the current set of the one or more uploaded tasks.

A person skilled in the art would understand that the scope of the disclosure is not limited to determining the reputation scores of the crowdworkers by using the above equation. The reputation scores of the crowdworkers may be determined by using any suitable technique.

The disclosed embodiments encompass numerous advantages. The crowdsourced task is assigned redundantly to the crowdworkers with a minimum reputation score. Therefore, the responses received would generally be of an acceptable quality. A sub-task is accepted as complete only when a certain number of crowdworkers provide similar sub-responses to the sub-task. Hence, the quality of the accepted sub-responses is better as it is based on a consensus of a certain number of people with a minimum reputation score. Moreover, the crowdworkers are validated with the help of one or more test sub-tasks within the task. This keeps spamming under control. The reputation scores of crowdworkers who fail in the one or more test sub-tasks may be reduced thereby affecting their future task assignment prospects. Thus, the overall quality of completed sub-task is maintained, while discouraging spamming.

The crowdsourced task has better throughput as the task acceptance is based on the sub-task level instead of the task level. The number of permissible re-assignments of a task (re-assignment degree) bounds the task throughput within a certain acceptable limit. The cost associated with crowdsourcing the task also reduces due to the acceptable task throughput. The number of times the task needs to be re-assigned is reduced as the sub-task level consensus is achieved faster than the task level consensus between the crowdworkers. This facilitates the faster completion of the entire task with a lower associated cost.

Another advantage of the various disclosed embodiments is that the crowdworkers are remunerated based on a sub-task level consensus instead of a task level consensus. Although, a task may not be complete as a whole, but the crowdworkers are remunerated for their genuine efforts leading to the completion of one or more sub-tasks. Moreover, the crowdworker responses are not discarded immediately if the crowdworkers do not provide similar sub-responses to one or more sub-tasks (the second set of sub-tasks). These sub-responses (the second set of sub-responses) are saved for future comparisons. After the task is re-assigned, there is a possibility that one or more received sub-responses (from the second set of responses) make the similar sub-response count of the one or more sub-tasks exceed the agreement degree of the task. Thus, the earlier crowdworkers are also remunerated along with the recent crowdworkers. This increases the crowdworker loyalty and further encourages them to take up more tasks and perform them well.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be RAM or ROM. The computer system further comprises a storage device, which may be an HDD or a removable storage drive such as a floppy-disk drive, optical-disk drive, and the like. The storage device may also be a means for loading computer programs or other instructions onto the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through the I/O interface.

In order to process input data, the computer system executes a set of instructions that is stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for crowdsourcing a task have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the systems, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for crowdsourcing a task, the method comprising:
presenting the task to one or more crowdworkers based on a reputation score associated with each of the one or more crowdworkers and a degree of redundancy associated with the task, wherein the task comprises one or more sub-tasks;
receiving a plurality of responses for the task from the one or more crowdworkers, wherein each response from the plurality of responses comprises one or more sub-responses, wherein each of the one or more sub-responses corresponds to a response for a sub-task of the one or more sub-tasks;
identifying a first set of sub-tasks from the one or more sub-tasks based on a first set of similar sub-responses received for the first set of sub-tasks from the plurality of responses and a first predetermined number; and
remunerating a first set of crowdworkers from the one or more crowdworkers, wherein the first set of crowdworkers have provided the first set of similar sub-responses for the first set of sub-tasks,
wherein the method is performed by a processor on a computing device.

2. The method of claim 1, wherein the degree of redundancy associated with the task corresponds to a maximum number of crowdworkers who are presented the task.

3. The method of claim 1, wherein the first predetermined number corresponds to a minimum number of similar sub-responses required for the identification of the first set of sub-tasks.

4. The method of claim 1 further comprising storing sub-responses received for a second set of sub-tasks, wherein the second set of sub-tasks corresponds to the one or more sub-tasks excluding the identified first set of sub-tasks.

5. The method of claim 4 further comprising presenting the task to a second set of crowdworkers from the one or more crowdworkers based on a second predetermined number and the redundancy degree associated with the task, such that a second set of sub-responses is received from the second set of crowdworkers for the second set of sub-tasks, wherein the second predetermined number corresponds to a maximum number of permissible re-assignments of the task.

6. The method of claim 5 further comprising identifying at least one sub-task from the second set of sub-tasks based on a second set of similar sub-responses for the at least one sub-task from the second set of sub-responses, and a third set of similar sub-responses for the at least one sub-task from the stored sub-responses.

7. The method of claim 6, wherein a sum of the second set of similar sub-responses and the third set of similar sub-responses is at least the first predetermined number.

8. The method of claim 6 further comprising remunerating a third set of crowdworkers from the one or more crowdworkers, wherein the third set of crowdworkers have provided the similar sub-responses for the at least one sub-task in the second set sub-tasks.

9. The method of claim 6 further comprising modifying the reputation score associated with each of the one or more crowdworkers based on the identification of the first set of sub-tasks and the at least one sub-task.

10. A crowdsourcing management system for managing crowdsourcing of a task, the crowdsourcing management system comprising:
a processor; and
a memory comprising:
a task manager configured to present the task to one or more crowdworkers based on a reputation score associated with each of the one or more crowdworkers and a degree of redundancy associated with the task, wherein the task comprises one or more sub-tasks;
a communication manager configured to receive a plurality of responses for the task from the one or more crowdworkers, wherein each response from the plurality of responses comprises one or more sub-responses, wherein each of the one or more sub-responses corresponds to a response for a sub-task of the one or more sub-tasks;
a redundancy handler configured to identify a first set of sub-tasks from the one or more sub-tasks based on a first set of similar sub-responses received for the first set of sub-tasks from the plurality of responses and a first predetermined number; and
a remuneration manager configured to remunerate a first set of crowdworkers from the one or more crowdworkers, wherein the first set of crowdworkers have provided the first set of similar sub-responses for the first set of sub-tasks.

11. The crowdsourcing management system of claim 10, wherein the degree of redundancy associated with the task corresponds to a maximum number of crowdworkers who are presented the task.

12. The crowdsourcing management system of claim 10, wherein the first predetermined number corresponds to a minimum number of similar sub-responses required for the identification of the first set of sub-tasks.

13. The crowdsourcing management system of claim 10, wherein the redundancy handler is further configured to store sub-responses received for a second set of sub-tasks, wherein the second set of sub-tasks corresponds to the one or more sub-tasks excluding the identified first set of sub-tasks.

14. The crowdsourcing management system of claim 13, wherein the task manager is further configured to present the task to a second set of crowdworkers from the one or more crowdworkers based on a second predetermined number and the redundancy degree associated with the task, such that a second set of sub-responses is received from the second set of crowdworkers for the second set of sub-tasks, wherein the second predetermined number corresponds to a maximum number of permissible re-assignments of the task.

15. The crowdsourcing management system of claim 14, wherein the redundancy handler is further configured to identify at least one sub-task from the second set of sub-tasks based on a second set of similar sub-responses for the at least one sub-task from the second set of sub-responses, and a third set of similar sub-responses for the at least one sub-task from the stored sub-responses.

16. The crowdsourcing management system of claim 15, wherein a sum of the second set of similar sub-responses and the third set of similar sub-responses is at least the first predetermined number.

17. The crowdsourcing management system of claim 15, wherein the remuneration manager is further configured to remunerate a third set of crowdworkers from the one or more crowdworkers, wherein the third set of crowdworkers have provided the similar sub-responses for the at least one sub-task in the second set sub-tasks.

18. The crowdsourcing management system of claim 15 further comprising a crowdworker manager configured to modify the reputation score associated with each of the one or more crowdworkers based on the identification of the first set of sub-tasks and the at least one sub-task.

19. A computer program product for use with a computing device, the computer program product comprising a non-transitory computer-usable medium having a computer readable program code embodied therein for crowdsourcing a task, the computer readable program code executable by a processor in the computing device for:
presenting the task to one or more crowdworkers based on a reputation score associated with each of the one or more crowdworkers and a degree of redundancy associated with the task, wherein the task comprises one or more sub-tasks, wherein the degree of redundancy associated with the task corresponds to a maximum number of crowdworkers who are presented the task;
receiving a plurality of responses for the task from the one or more crowdworkers, wherein each response from the plurality of responses comprises one or more sub-responses, wherein each of the one or more sub-responses corresponds to a response for a sub-task of the one or more sub-tasks;
identifying a first set of sub-tasks from the one or more sub-tasks based on a first set of similar sub-responses received for the first set of sub-tasks from the plurality of responses and a first predetermined number; and
remunerating a first set of crowdworkers from the one or more crowdworkers, wherein the first set of crowdworkers have provided the first set of similar sub-responses for the first set of sub-tasks.

20. The computer program product 19, wherein the first predetermined number corresponds to a minimum number of the similar sub-responses required for the identification of the first set of sub-tasks.
